(19) United States
(12) Patent Application Publication
(10) Pub. No.: US 2013/0163290 A1
(43) Pub. Date: Jun. 27, 2013

(54) POWER SUPPLY APPARATUS

(71) Applicants: Gun Woo Moon, Daejeon (KR); Bong Chul Kim, Incheon (KR); Jin Wook Kim, Suwon (KR); Chong Eun Kim, Suwon (KR); Dong Jin Park, Suwon (KR); Don Sik Kim, Suwon (KR); Hong Sun Park, Suwon (KR)

(72) Inventors: Gun Woo Moon, Daejeon (KR); Bong Chul Kim, Incheon (KR); Jin Wook Kim, Suwon (KR); Chong Eun Kim, Suwon (KR); Dong Jin Park, Suwon (KR); Don Sik Kim, Suwon (KR); Hong Sun Park, Suwon (KR)

(73) Assignee: SAMSUNG ELECTRO-MECHANICS CO., LTD./Korea Advanced Institute of Science and Technology

(21) Appl. No.: 13/441,518

(22) Filed: Apr. 6, 2012

(30) Foreign Application Priority Data
Dec. 23, 2011 (KR) 10-2011-0141560

(51) Int. Cl. H02M 3/335

(52) U.S. Cl. 363/21.02

(57) ABSTRACT

There is provided an LLC type power supply apparatus for controlling switching of a secondary side rectifier based on primary side current, particularly, controlling switching of the secondary-side rectifier based on primary side resonance current and magnetizing current. The power supply apparatus includes: a switching unit switching input power; a transformer unit transforming the switched power from the switching unit; a rectifying unit including a rectifier turned on and turned off in response to a control signal to rectify the transformed power; a controlling unit controlling the switching of the switching unit, based on an output power of the rectifying unit; and a switching controlling unit controlling turning-on and turning-off of the rectifier of the rectifying unit, based on current flowing in the transformer unit.

### CROSS-REFERENCE TO RELATED APPLICATIONS

This application claims the priority of Korean Patent Application No. 10-2011-0141560 filed on Dec. 23, 2011, in the Korean Intellectual Property Office, the disclosure of which is incorporated herein by reference.

### BACKGROUND OF THE INVENTION

1. Field of the Invention

The present invention relates to a power supply apparatus in which conduction loss is reduced in a synchronous rectifier.

2. Description of the Related Art

Various electronic apparatuses meeting various user requirements have been implemented. These electronic apparatuses may use a power supply apparatus supplying operating power thereto, in order to implement various functions included therein.

The power supply apparatus may generally use a switching mode power supply scheme due to advantages thereof, such as power conversion efficiency, miniaturizability, and the like.

As the power supply apparatus of this switching mode power supply scheme, there may be provided a flyback-type power supply apparatus, a forward-type power supply apparatus, or the like, and there may also be provided an inductor-inductor-capacitor (LLC) resonance-type power supply apparatus, widely used due to advantages thereof, such as power conversion efficiency, a reduced circuit area, and the like.

The LLC resonance-type power supply apparatus described above maybe driven at a high frequency, since it may perform zero voltage switching in the entire load area.

However, in the LLC resonance-type power supply apparatus, since a secondary side current waveform is discontinuous, when a root mean square (RMS) value of the current increases, conduction loss also increases. In order to solve this defect, a synchronous rectifier (SR) may be used as a secondary side rectifying diode. In order to drive the synchronous rectifier, voltage from the synchronous rectifier is sensed, and the sensed voltage is compared with a preset reference voltage to turn the synchronous rectifier on or off.

However, an error may occur in sensing voltage due to leakage inductance of the rectifier and a leakage inductance component of a printed circuit board with which the LLC resonance-type power supply apparatus is provided. Therefore, the rectifier is turned off in advance, such that the secondary side current flows in a body diode of the rectifier, thereby increasing conductance loss.

### SUMMARY OF THE INVENTION

An aspect of the present invention provides an LLC type power supply apparatus capable of controlling the switching of a secondary side rectifier based on primary side current, particularly, controlling the switching of the secondary-side rectifier based on a primary side resonance current and a primary side magnetizing current and detecting the primary side magnetizing current based on control of the switching at a primary side.

According to an aspect of the present invention, there is provided a power supply apparatus including: a switching unit switching input power; a transformer unit transforming the switched power from the switching unit; a rectifying unit including a rectifier turned on and turned off in response to a control signal to thus rectify the transformed power; a controlling unit controlling the switching of the switching unit, based on an output power of the rectifying unit; and a switching controlling unit controlling turning-on and turning-off of the rectifier of the rectifying unit, based on current flowing in the transformer unit.

The transformer unit may include: a transformer having a magnetizing inductance component and a primary winding receiving the switched power and a secondary winding forming a turns ratio with the primary winding to transform the switched power; and a resonance inductor and a resonance capacitor LLC-resonating together with the magnetizing inductance component of the transformer.

The switching controlling unit may control the turning-on and the turning-off of the rectifier, based on a magnetizing current from the magnetizing inductance component and a resonance current flowing in the resonance inductor.

The rectifying unit may include: a first rectifier connected to one end of the secondary winding; a second rectifier connected to the other end of the secondary winding; and a capacitor connected to the secondary winding to stabilize the rectified power.

The switching controlling unit may include: a current detector detecting the magnetizing current from the magnetizing inductance component and the resonance current flowing in the resonance inductor; and a rectifying switching controller controlling turning-on and the turning-off of the first and second rectifiers according to a current detector detection result.

The current detector may include: a resonance current detector detecting the resonance current flowing in the resonance inductor; and a magnetizing current detector detecting the magnetizing current from the magnetizing inductance component, based on a switching signal of the controlling unit.

The magnetizing current detector may include: a first transistor group including a first N-type transistor and a first P-type transistor connected in series between a driving power terminal supplying a preset driving power and a ground, the first N-type transistor and the first P-type transistor each having a base receiving the switching signal of the controlling unit, respectively; a second transistor group including a second N-type transistor and a second P-type transistor connected in series between the driving power terminal and the ground and each having a base receiving the switching signal of the controlling unit, respectively; a detecting transformer having a primary winding having voltage applied thereto provided between a connection point between the first N-type transistor and the first P-type transistor of the first transistor group and a connection point between the second N-type transistor and the second P-type transistor of the second transistor group, and a secondary winding electromagnetically coupled to the primary winding; a pseudo magnetizing inductor connected to the first winding to generate a current gradient similar to a current gradient generated by the magnetizing inductance component according to the turns ratio of the transformer; and a resistor detecting current induced in the secondary winding as voltage.

The rectifying switching controller may include: a first comparator having a positive terminal receiving the detected resonance current and a negative terminal receiving the detected magnetizing current and comparing the detected resonance current and the detected magnetizing current with each other to control the switching of the first rectifier; and a second comparator having a positive terminal receiving the detected magnetizing current and a negative terminal receiving the detected resonance current and comparing the detected resonance current and the detected magnetizing current with each other to control the switching of the second rectifier.

The controlling unit may include: a detector detecting output voltage of the rectifying unit and comparing the detected voltage to a preset reference voltage; and a switching signal generator providing the switching signal controlling the switching of the switching unit according to a comparison result of the detector.

The switching unit may include a first switch and a second switch connected in series between input power terminals to which the input power is input, and the first switch and the second switch are alternately switched in response to the switching signal.

The switching signal generator may provide a first switching signal switching the first switch on and off and a second switching signal switching the second switch on and off.

The first transistor group of the magnetizing current detector may receive the first switching signal, and the second transistor group thereof may receive the second switching signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a power supply apparatus according to an embodiment of the present invention;

FIG. 2 is a graph showing signal waveforms of main units of the power supply apparatus of the embodiment of the present invention;

FIG. 3 is a schematic circuit diagram of a magnetizing current detector used in the power supply apparatus according to the embodiment of the present invention;

FIG. 4 is a graph showing signal waveforms of a magnetizing current detector used in the power supply apparatus according to the embodiment of the present invention; and FIG. 5 is a schematic configuration diagram of a rectifying switching controller used in the power supply apparatus according to the embodiment of the present invention.

### DETAILED DESCRIPTION OF THE EMBODIMENTS

Hereinafter, embodiments will be described in detail with reference to the accompanying drawings so that they can be easily practiced by those skilled in the art to which the present invention pertains.

However, in describing embodiments of the present invention, detailed descriptions of well-known functions or constructions will be omitted so as not to obscure the description of the present invention with unnecessary detail.

In addition, like or similar reference numerals denote parts performing similar functions and actions throughout the drawings.

Furthermore, a case in which any one part is connected to the other part includes a case in which the parts are directly connected to each other and a case in which the parts are indirectly connected to each other with other elements interposed therebetween.

In addition, unless explicitly described to the contrary, “comprising” any components will be understood to imply the inclusion of other components but not the exclusion of any other components.

Embodiments of the present invention will now be described in detail with reference to the accompanying drawings.

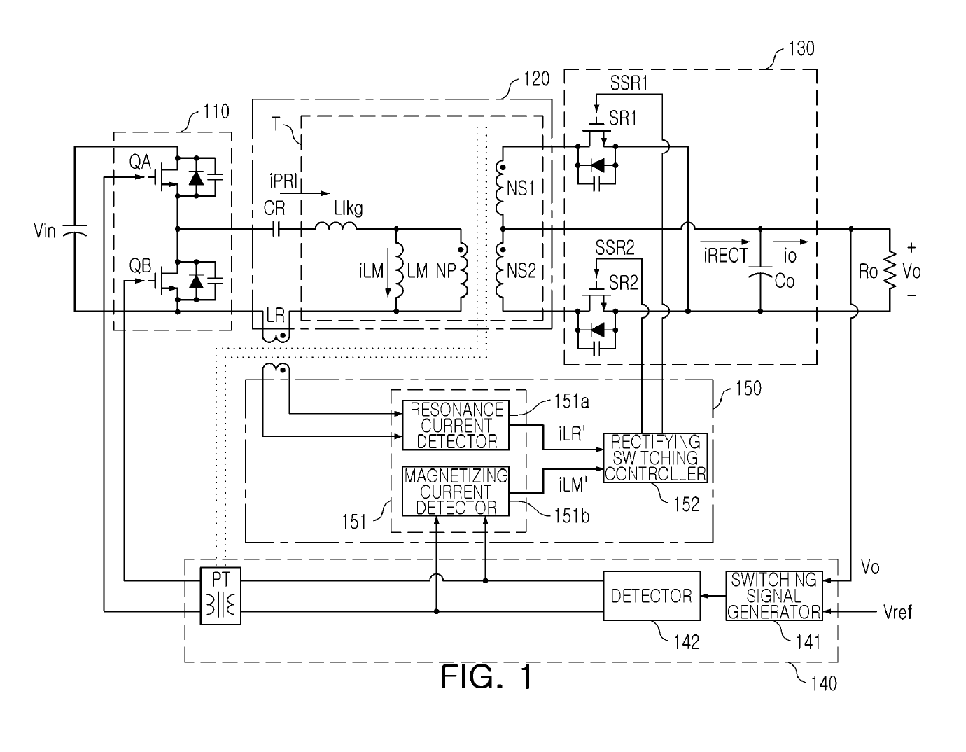

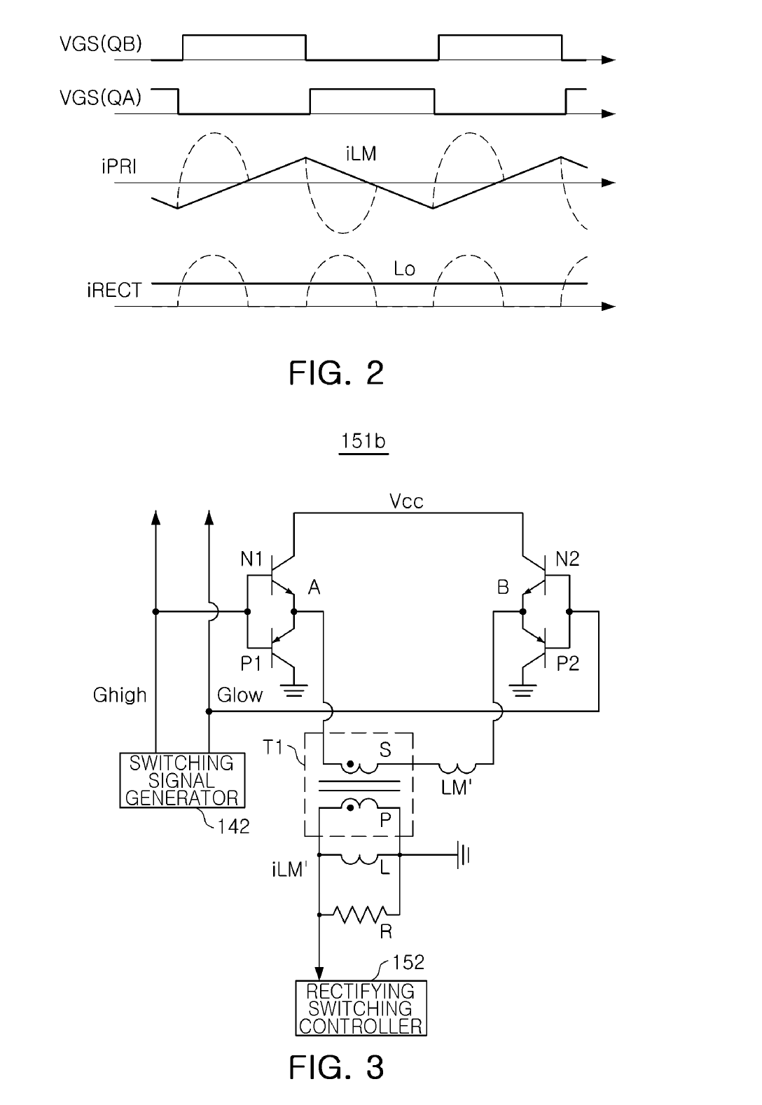

FIG. 1 is a schematic block diagram of a power supply apparatus according to an embodiment of the present invention; and FIG. 2 is a graph showing signal waveforms of main units of the power supply apparatus according to the embodiment of the present invention.

Referring to FIG. 1, the power supply apparatus 100 according to the embodiment of the present invention may include a switching unit 110, a transformer unit 120, a rectifying unit 130, a controlling unit 140, and a switching controlling unit 150.

The switching unit 110 may switch an input power Vin. To this end, the switching unit 100 may include first and second switches QA and QB connected in series between input power terminals to which the input power Vin is input.

The first and second switches QA and QB may be alternately switched as shown in FIG. 2. To this end, the first and second switches QA and QB may receive switching signals from the controlling unit 140.

The transformer unit 120 may transform a voltage level of the switched power from the switching unit 110 to a preset voltage level and output the transformed voltage.

Therefore, the transformer unit 120 may include a transformer T, wherein the transformer T may have a primary winding NP receiving the switched power and secondary windings NS1 and NS2 transforming the voltage level of the switched power input to the primary winding NP according to a turns ratio formed by electromagnetic coupling to the primary winding NP and outputting the transformed voltage level. In addition, the transformer T may include a leakage inductance component Llkg and a magnetizing inductance component LM.

Further, the transformer unit 120 may include a resonance inductor LR and a resonance capacitor CR, each formed between the switching unit 110 and both ends of the primary winding NP, wherein the resonance inductor LR and resonance capacitor CR may configure an LLC resonance tank, together with the magnetizing inductance component LM of the transformer T. Therefore, the power supply apparatus 100 according to the embodiment of the present invention may perform a power conversion operation in an LLC resonance scheme.

The rectifying unit 130 may include first and second rectifiers SR1 and SR2, each connected to both ends of the secondary winding NS1 and NS2, and a capacitor Co connected to the secondary windings NS1 and NS2.

The first and second rectifiers SR1 and SR2 may be alternately switched and may rectify power transformed from the secondary windings NS1 and NS2.

The capacitor Co may stabilize the rectified power iRECT to output output power io, as shown in FIG. 2.

The controlling unit 140 may control the switching of the switching unit 110, based on voltage Vo of the output power.

To this end, the controlling unit 140 may include a detector 141 and a switching signal generator 142.

The detector 141 may detect a voltage level Vo of the output power and compare the detected voltage level with a preset reference voltage Vo_ref to transfer the comparison result to the switching signal generator 142.

The switching signal generator 142 may provide a switching signal alternately switching the first switch QA and the second switch QB to the switching unit 110 according to the comparison result of the detector 141. In addition, the switching signal generator 142 may also provide the switching signal to the switching controlling unit 150.

The switching controlling unit 150 may control switching-on and switching-off of the first and second rectifiers SR1 and SR2. The first and second rectifiers SR1 and SR2 may be alternately switched on and off. To this end, the switching controlling unit 150 may provide each of first and second rectifying switching signals SSR1 and SSR2 to the first and second rectifiers SR1 and SR2.

The switching controlling unit 150 may include a current detector 151 and a rectifying switching controller 152.

The current detector 151 may detect current flowing in the transformer unit 120. More specifically, the current detector 151 may detect resonance current iLR flowing in the resonance inductor LR of the transformer unit 120 and magnetizing current iLM flowing in a magnetizing inductance component LM.

To this end, the current detector 151 may include a resonance current detector 151a and a magnetizing current detector 151b.

The current detected by the resonance current detector 151a and the magnetizing current detector 151b may be transferred to the rectifying switching controller 152.

The switching controller 152 may provide first and second rectifying switching signals SSR1 and SSR2, alternately switching the first and second rectifiers SR1 and SR2 on the basis of the current detected by the resonance current detector 151a and the magnetizing current detector 151b.

FIG. 5 is a schematic configuration diagram of a rectifying switching controller of the power supply apparatus according to the embodiment of the present invention.

Referring to FIG. 5, the rectifying switching controller 152 may include first and second comparators OP1 and OP2.

The first comparator OP1 may have a positive terminal receiving a detected resonance current iLR′ and a negative terminal receiving a detected magnetizing current iLM′ and may compare the detected resonance current iLR′ and the detected magnetizing current iLM′ with each other to provide a first rectifying switching signal SSR1 controlling the switching of the first rectifier SR1.

The second comparator OP2 may have a positive terminal receiving the detected magnetizing current iLM′ and a negative terminal receiving the detected resonance current iLR′ and compare the detected resonance current iLR′ and the detected magnetizing current iLM′ with each other to provide a second rectifying switching signal SSR2 controlling the switching of the second rectifier SR2.

Meanwhile, the resonance current iLR may be detected by receiving the current flowing in the resonance inductor LR. However, with regard to the magnetizing current iLM, since the magnetizing inductance component LM is possessed by the transformer T itself, a current iPRI input to the transformer T may be detected, but the magnetizing current iLM may not be directly detected due to the leakage inductance component Llkg of the transformer T.

Therefore, the power supply apparatus 100 according to the embodiment of the present invention proposes the following magnetizing current detector 151b.

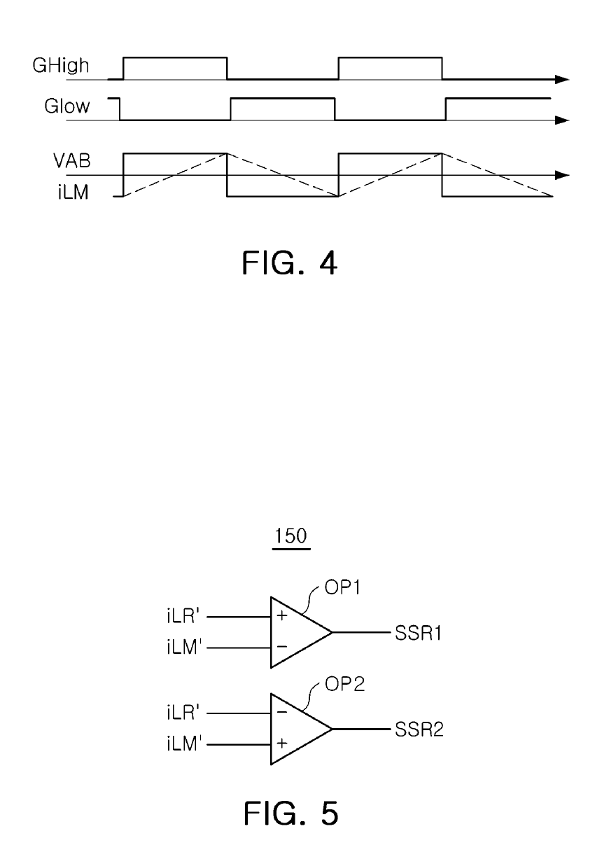

FIG. 3 is a schematic circuit diagram of a magnetizing current detector used in the power supply apparatus according to the embodiment of the present invention; and FIG. 4 is a graph showing signal waveforms of a magnetizing current detector used in the power supply apparatus according to the embodiment of the present invention.

Referring to FIG. 3, the magnetizing current detector 151b may include a first switch group N1 and P1, a second switch group N2 and P2, a detecting transformer T1, a pseudo magnetizing inductor LM′, and a resistor R. Here, the inductor L may be included in the detecting transformer T1.

The first switch group N1 and P1 may include a first N-type transistor N1 and a first P-type transistor P1.

The first N-type transistor N1 and the first P-type transistor P1 maybe connected in series between a driving power terminal supplying a preset driving power Vcc and a ground and may each have a base receiving a first switching signal Ghigh from the switching signal generator 142, respectively.

The second switch group N2 and P2 may include a second N-type transistor N2 and a second P-type transistor P2.

The second N-type transistor N2 and the second P-type transistor P2 may be connected in series between the driving power terminal supplying the preset driving power Vcc and the ground and may each have a base receiving a second switching signal Glow from the switching signal generator 142, respectively.

Since the first and second switching signals of the switching signal generator 142, Ghigh and Glow, are alternately switched, a voltage VAB between a connection point A between the first P-type transistor P1 and the first N-type transistor N1 and a connection point B between the second N-type transistor N2 and the second P-type transistor P2 may be represented as shown in FIG. 4.

Both ends of a primary winding P of the detecting transformer T1 may be respectively connected to the connection point A between the first N-type transistor N1 and the first P-type transistor P1 and the connection point B between the second N-type transistor N2 and the second P-type transistor P2 to thereby be applied with the voltage VAB, a secondary winding S thereof may receive the applied VAB, and the resistor R may be connected in parallel with both ends of the secondary winding S to allow a current level of the received power to be detected as voltage.

Here, one end of the first winding P and the connection point B between the second N-type transistor N2 and the second P-type transistor P2 may include the pseudo magnetizing inductor LM′ formed therebetween.

The magnetizing current iLM of the magnetizing inductance component LM may be determined by switching frequencies and duties of the first and second switches QA and QB of the switching unit 110, a voltage level Vo of the output power, a turns ratio of the transformer T, and an inductance value of the magnetizing inductance component LM.

It may be represented by the following Equation.

$${i}_{LM} = \frac{{nV}_{o}}{{L}_{M}} {DT}_{s} , \\ n = \frac{{N}_{p}}{{N}_{s}} \qquad ( Equation )$$

where iLM refers to magnetizing current, n refers to a turns ratio between the primary winding Np and the secondary winding Ns=Ns1=Ns2, LM refers to an inductance value of a magnetizing inductance component, D refers to a duty, and Is refers to a switching cycle.

As described above, since the switching frequency and the duty of the first and second switches QA and QB are required in order to determine the magnetizing current iLM, the first and second signals Ghigh and Glow of the switching signal generator 142 may be applied.

Since the pseudo magnetizing inductor LM′ is connected to the primary winding, an inductance value thereof may be determined according to the turns ratio of the transformer. Therefore, a gradient of the current, equal to or similar to a gradient of the current provided by the magnetizing inductance component, may be formed, as shown in FIG. 4.

Therefore, the rectifying switching controller 152 may have the detected magnetizing current iLM′ applied thereto.

As described above, according to the embodiments of the present invention, the switching of the secondary side rectifier may be controlled based on the primary side resonance current and the primary side magnetizing current, whereby conductance loss in the secondary side rectifier may be reduced and the primary side magnetizing current may be easily detected, based on the primary side switching signal in order to detect the primary side magnetizing current.

As set forth above, according to the embodiments of the present invention, the switching of the secondary side rectifier may be controlled based on the primary side resonance current, particularly, based on the primary side resonance current and the primary side magnetizing current, whereby the conduction loss of the secondary side rectifier may be reduced.

While the present invention has been shown and described in connection with the embodiments, it will be apparent to those skilled in the art that modifications and variations can be made without departing from the spirit and scope of the invention as defined by the appended claims.

What is claimed is:

1. A power supply apparatus comprising:
a switching unit switching input power;
a transformer unit transforming the switched power from the switching unit;
a rectifying unit including a rectifier turned on and turned off in response to a control signal to thus rectify the transformed power;
a controlling unit controlling the switching of the switching unit, based on an output power of the rectifying unit; and
a switching controlling unit controlling turning-on and turning-off of the rectifier of the rectifying unit, based on current flowing in the transformer unit.

2. The power supply apparatus of claim 1, wherein the transformer unit includes:
a transformer having a magnetizing inductance component and a primary winding receiving the switched power and a secondary winding forming a turns ratio with the primary winding to transform the switched power; and
a resonance inductor and a resonance capacitor inductor-inductor-capacitor(LLC)-resonating together with the magnetizing inductance component of the transformer.

3. The power supply apparatus of claim 2, wherein the switching controlling unit controls the turning-on and the turning-off of the rectifier, based on a magnetizing current from the magnetizing inductance component and a resonance current flowing in the resonance inductor.

4. The power supply apparatus of claim 3, wherein the rectifying unit includes:
a first rectifier connected to one end of the secondary winding;
a second rectifier connected to the other end of the secondary winding; and
a capacitor connected to the secondary winding to stabilize the rectified power.

5. The power supply apparatus of claim 4, wherein the switching controlling unit includes:
a current detector detecting the magnetizing current from the magnetizing inductance component and the resonance current flowing in the resonance inductor; and
a rectifying switching controller controlling turning-on and the turning-off of the first and second rectifiers according to a current detector detection result.

6. The power supply apparatus of claim 5, wherein the current detector includes:
a resonance current detector detecting the resonance current flowing in the resonance inductor; and
a magnetizing current detector detecting the magnetizing current from the magnetizing inductance component, based on a switching signal of the controlling unit.

7. The power supply apparatus of claim 6, wherein the magnetizing current detector includes:
a first transistor group including a first N-type transistor and a first P-type transistor connected in series between a driving power terminal supplying a preset driving power and a ground, the first N-type transistor and the first P-type transistor each having a base receiving the switching signal of the controlling unit, respectively;
a second transistor group including a second N-type transistor and a second P-type transistor connected in series between the driving power terminal and the ground and each having abase receiving the switching signal of the controlling unit, respectively;
a detecting transformer including a primary winding having voltage applied thereto provided between a connection point between the first N-type transistor and the first P-type transistor of the first transistor group and a connection point between the second N-type transistor and the second P-type transistor of the second transistor group, and a secondary winding electromagnetically coupled to the primary winding;
a pseudo magnetizing inductor connected to the first winding to generate a current gradient similar to a current gradient generated by the magnetizing inductance component according to the turns ratio of the transformer; and
a resistor detecting current induced in the secondary winding as voltage.

8. The power supply apparatus of claim 6, wherein the rectifying switching controller includes:
a first comparator having a positive terminal receiving the detected resonance current and a negative terminal receiving the detected magnetizing current and comparing the detected resonance current and the detected magnetizing current with each other to control the switching of the first rectifier; and
a second comparator having a positive terminal receiving the detected magnetizing current and a negative terminal receiving the detected resonance current and comparing the detected resonance current and the detected magnetizing current with each other to control the switching of the second rectifier.

9. The power supply apparatus of claim 7, wherein the controlling unit includes:
a detector detecting output voltage of the rectifying unit and comparing the detected voltage to a preset reference voltage; and
a switching signal generator providing the switching signal controlling the switching of the switching unit according to a comparison result of the detector.

10. The power supply apparatus of claim 9, wherein the switching unit includes a first switch and a second switch connected in series between input power terminals to which the input power is input, and
the first switch and the second switch are alternately switched in response to the switching signal.

11. The power supply apparatus of claim 10, wherein the switching signal generator provides a first switching signal switching the first switch on and off and a second switching signal switching the second switch on and off.

12. The power supply apparatus of claim 10, wherein the first transistor group of the magnetizing current detector receives the first switching signal, and the second transistor group thereof receives the second switching signal.
